(19) United States
(12) Patent Application Publication
(10) Pub. No.: US 2009/0193859 A1
(43) Pub. Date: Aug. 6, 2009

(54) AUTOMATIC LOCKING SYSTEM AND DEADBOLT HAVING THE SAME

(75) Inventors: Michael Kwon, Annandale, VA (US); Ho-Guen Park, Seoul (KR)

Correspondence Address: H.C. PARK & ASSOCIATES, PLC, 8500 LEESBURG PIKE, SUITE 7500, VIENNA, VA, 22182, US

(73) Assignee: SUNNECT, INC., Annandale, VA (US)

(21) Appl. No.: 12/025,176

(22) Filed: Feb. 4, 2008

(51) Int. Cl. E05B 65/00; E05B 47/00

(52) U.S. Cl. 70/91; 70/276

(57) ABSTRACT

An automatic locking system includes a magnetic sensor and a magnet. The magnetic sensor sends a signal if the proximity to the magnet equals or is less than a predetermined distance. A controller drives a motor to extend a throw bolt in response to receiving the signal from the magnetic sensor. An electronic deadbolt includes the automatic locking system. The magnetic sensor is arranged in a deadbolt assembly inside the door on which the electronic deadbolt is arranged, and the magnet is arranged in or adjacent to a strike lining box on the door frame so the automatic locking system is hidden from view. An electronic deadbolt includes a master function that may be activated or deactivated by a user. If the master function is activated, a master passcode and master tag may be used to operate the electronic deadbolt and access programming buttons.

### BACKGROUND OF THE INVENTION

1. Field of the Invention

The present invention relates to an automatic locking system and a deadbolt having the same.

2. Discussion of the Background

Conventional deadbolts generally include keyholes, which may be tampered with by potential intruders. Various deadbolt arrangements have been developed to include alternative methods and mechanisms for opening a deadbolt other than a traditional key.

For example, U.S. Pat. No. 5,609,051 issued to Donaldson, is entitled “KEYLESS ENTRY SYSTEM FOR REPLACEMENT OF EXISTING KEY LOCKS” and discloses a deadbolt operated by keypad.

U.S. Pat. No. 5,923,264 issued to Lavelle, et al., is entitled “MULTIPLE ACCESS ELECTRONIC LOCK SYSTEM” and discloses a lock that may be operated by keypad or electronic touch-key.

U.S. Pat. No. 7,069,755 issued to Lies, et al., is entitled “DEADBOLT LOCK WITH ELECTRONIC TOUCH-KEY” and discloses a deadbolt that may be operated by electronic touch-key.

However, since a keyhole is not included as a back-up mechanism for entry in the event of power failure or damage to the keypad or circuitry that responds to input of an electronic touch-key, these references do not provide an alternate way for unlocking the deadbolt.

Additionally, deadbolts are widely recognized as more secure than traditional spring latches. However, deadbolts have traditionally been required to be locked manually to slide the throw bolt of the deadbolt assembly into a strike lining box mounted on a door frame.

U.S. Pat. No. 6,449,995 issued to Paolini et al., is entitled “AUTOMATIC DEADBOLT” and discloses a deadbolt that locks automatically by a mechanical spring that is wound when the deadbolt is unlocked and opened. When the mechanical spring is wound, a timer begins to run. When the timer ends, the spring is released and the deadbolt locks.

However, because the door may be closed for some time before the deadbolt automatically locks, there is a chance that an intruder may be able to open the door before the automatic locking function has occurred. Additionally, if the door is held open for a significant amount of time, the deadbolt may lock before the door is closed.

Additionally, in conventional deadbolts, once an external panel is removed, the intruder has access to the deadbolt unlocking mechanisms inside the deadbolt panel, and can unlock the deadbolt.

Accordingly, there is a need for a deadbolt that locks automatically without the drawbacks of conventional deadbolts or conventional spring latches.

There is also a need for deadbolt with increased protection against tampering from potential intruders, while also being well-suited for use inside a building or outside while exposed to the elements.

### SUMMARY OF THE INVENTION

This invention provides an automatic locking system.

The present invention also provides a deadbolt including an automatic locking system.

The present invention also provides a deadbolt including a master function that can be turned on or turned off at the discretion of a user.

Additional features of the invention will be set forth in the description which follows, and in part will be apparent from the description, or may be learned by practice of the invention.

The present invention discloses an automatic door-locking system, including a magnet arranged on a door frame, a magnetic sensor arranged on a door corresponding to the door frame, the magnetic sensor to sense a proximity of the magnet and to send a signal in response thereto, and a locking assembly comprising a throw bolt. Further, the throw bolt extends into a strike lining box on the door frame in response to a signal from the magnetic sensor.

The present invention also discloses a deadbolt, including an internal panel arranged on an interior side of a door, an external panel arranged on an exterior side of the door, a deadbolt assembly comprising a throw bolt, the deadbolt assembly being interposed between the internal panel and the external panel, a magnet arranged on a frame of the door, and a magnetic sensor arranged on the door, the magnet sensor to sense a proximity of the magnet and to send a signal in response thereto. Further, the throw bolt extends into a strike lining box on the door frame in response to a signal from the magnetic sensor.

The present invention also discloses an electronic deadbolt, including an internal panel comprising a controller and a motor, an external panel, a deadbolt assembly comprising a throw bolt, the throw bolt being extendable by the motor in response to a recognized command. Further, the controller comprises a master function, the master function being activated or deactivated by a user.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view of a deadbolt according to a first exemplary embodiment of the present invention.

FIG. 2 is an exploded elevation view of a deadbolt assembly according to a second exemplary embodiment of the present invention.

FIG. 3 is an exploded perspective view of an external body of the deadbolt shown in FIG. 1.

FIG. 4 is an exploded perspective view of an internal body of the deadbolt shown in FIG. 1.

FIG. 5 is an exploded perspective view of an electronic tag used with the deadbolt shown in FIG. 1.

FIG. 6 is a circuit diagram for the deadbolt shown in FIG. 1.

FIG. 7A is a flow chart showing a method for activating a master function in the deadbolt shown in FIG. 1.

FIG. 7B is a flow chart showing a method for deactivating a master function in the deadbolt shown in FIG. 1.

FIG. 7C is a flow chart showing a method for registering a master passcode using the master function in the deadbolt shown in FIG. 1.

FIG. 7D is a flow chart showing a method for registering a master electronic key using the master function in the deadbolt shown in FIG. 1.

FIG. 8 is a flow chart showing a method for receiving a user passcode by a deadbolt according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element is referred to as being “on”, “connected to” or “coupled to” another element, it can be directly on, connected or coupled to the other element, or intervening elements may be present. In contrast, if an element is referred to as being “directly on,” “directly connected to” or “directly coupled to” another element, there are no intervening elements present. Like numbers refer to like elements throughout. As used herein, the term “and/or” includes any and all combinations of one or more of the associated listed items.

It will be understood that, although the terms first, second, third etc. may be used herein to describe various elements, components, regions, and/or sections, these elements, components, regions, and/or sections should not be limited by these terms. These terms are only used to distinguish one element, component, region, or section from another region, layer or section. Thus, a first element, component, region, layer or section discussed below could be termed a second element, component, region, or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Thus, the regions illustrated in the figures are schematic in nature and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings. For the purposes of this description, the “interior” or “interior side” shall refer to a side of the door that is restricted from open access. Similarly, “exterior” or “exterior side” shall refer to a side of the door that is arranged opposite to the interior side. For example, on a door leading to an apartment unit, the interior side may correspond to the side facing inside the apartment unit, and the exterior side may correspond to the side facing a hallway or passageway. Thus, this terminology is used only for convenience, and is not intended to limit the application of the exemplary embodiments.

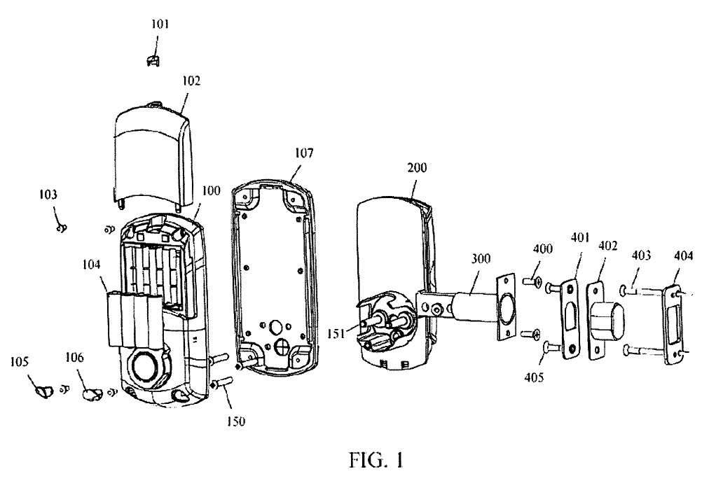

FIG. 1 is an exploded perspective view of a deadbolt according to a first exemplary embodiment of the present invention.

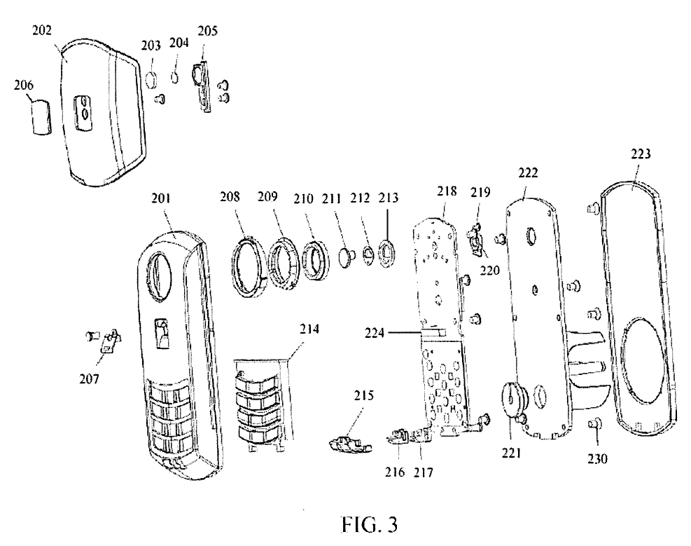

Referring to FIG. 1, an external body assembly 200 is arranged on the exterior side of a door (not shown), and is coupled to an internal body 100 arranged on the interior of the door through a penetration in the door. The components of the external body assembly 200 that are arranged in the penetration in the door shall be described in more detail below with reference to FIG. 3.

The internal body 100 includes a battery cover 102 to cover one or more receptacles in the internal body 100 for a power supply 104. The power supply 104 may include AA-sized batteries, but may alternately include batteries of another size, such as AAA, C, D, or 9 Volt (9V) dry-cell batteries, and/or other batteries such as lithium batteries or metal-hydride batteries, which may or may not be rechargeable. The battery cover 102 may be secured to the internal body 100 with a battery cover fastener 101. Alternatively, the power may be supplied from any other source, such as a power outlet, and batteries may be used as a back-up, batteries may be the primary power source and any other power source may be a back-up.

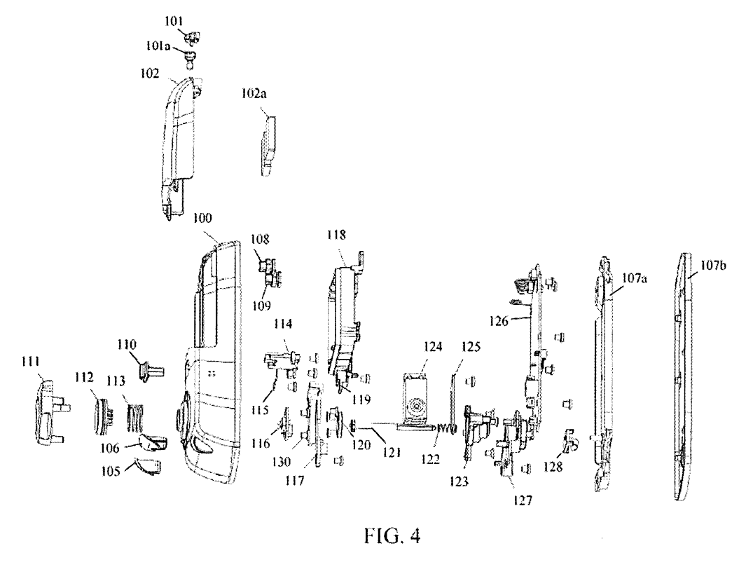

The internal body 100 may include upper and lower fixing screws 103 for coupling the internal body 100 to an internal bracket assembly 107. The internal bracket assembly 107 may include an internal back bracket 107a (shown in FIG. 4) and an internal gasket material, such as internal bracket rubber 107b (shown in FIG. 4), for protecting the door when the deadbolt is installed on the door. Upper fixing screws 103 may be covered by the battery cover 102 such that a user standing on the interior of the door does not see the upper fixing screws 103. Further, for aesthetic purposes, the lower fixing screws may be covered by lower screw covers 105 and 106 to improve the aesthetic appearance of the deadbolt.

The internal body 100 may be coupled to the external body assembly 200 with mounting screws 150, which are inserted into the mounting screw receptacles 151 of the external body assembly 200 that are arranged in the penetration in the door. As will be explained in more detail below, the mounting screw receptacles 151 may be included with or coupled to the external bracket 222 (shown in FIG. 3), which may be included in the external body assembly 200.

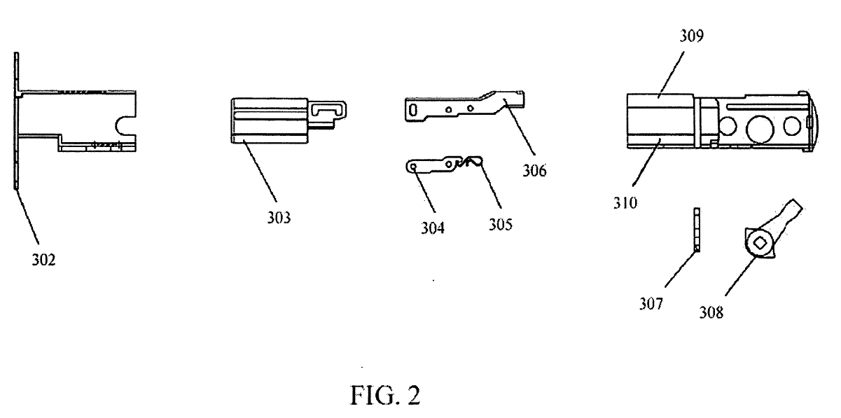

The deadbolt assembly 300 is coupled to the internal body 100 through a rotary bar 121 (shown on FIG. 4) and is arranged in a standard deadbolt assembly opening in the door (not shown). The deadbolt assembly 300 is coupled to the door through one or more deadbolt screws 400. The throw bolt 303 (shown on FIG. 2) is aligned with an opening in the door frame (not shown) when the door on which the deadbolt is arranged is closed.

A strike frame reinforcement plate 404 is arranged in the door frame opening and coupled thereto with reinforcement screws 403. A strike lining box 402 is also arranged in the door frame opening, and a portion of the strike lining box 402 is arranged in an opening in the strike frame reinforcement plate 404. A strike plate 401 with an opening therein is arranged over the strike lining box 402, and strike screws 405 couple the strike plate 401 and the strike frame reinforcement plate 404 to the door frame. The opening in the strike plate 401 corresponds with the opening in the strike lining box 402 when the components are arranged on the door frame to receive the throw bolt 303.

Specifically, as explained above, the throw bolt 303 of the deadbolt assembly 300 is aligned with an opening in the door frame (not shown) in which the strike lining box 402 is arranged when the door is closed. Thus, the throw bolt 303 extends into and retracts from the openings in the strike plate 401 and the strike lining box 402 when the door is closed and the deadbolt is respectively locked and unlocked.

FIG. 2 is an exploded elevation view of a deadbolt assembly according to a second exemplary embodiment of the present invention.

The deadbolt assembly shown in FIG. 2 may correspond to the deadbolt assembly 300 shown in FIG. 1. However, the embodiment of the present invention shown in FIG. 2 is not limited thereto, and may be used in a deadbolt having a different structure and/or arrangement of components than the deadbolt shown in FIG. 1.

Referring to the deadbolt assembly of FIG. 2, a deadbolt inner body 309 is arranged in a deadbolt outer body 302 and houses a rotary bar arm 308, which rotates in response to a rotation of the rotary bar 121 extending from the internal body 100. When the rotary bar arm 308 is turned into a position corresponding to a locked condition, which shall be referred to hereinafter as the “locked position,” an opening at the top of slider 306 engages the rotary bar arm 308 to prevent or restrict the rotary bar arm 308 from turning toward a position corresponding to an unlocked condition without rotation of the rotary bar 121 or the rotary bar arm 308. The deadbolt inner body 309 also includes a lock plate 307, which can be positioned so that the throw bolt 303 is properly aligned to fit the door in which the deadbolt is arranged. More specifically, the lock plate 307 can be adjusted according to the distance from a door edge to the center of the penetration in the door, which may be referred to as backset distance. Common backset distances may include 2⅜ inches and 2¾ inches, but are not limited thereto.

When the rotary bar arm 308 turns toward the locked position, the slider 306 slides toward a deadbolt plate 301, which is arranged along an outer surface edge of the door (not shown) in which the deadbolt assembly is arranged. The slider 306 is coupled to the throw bolt 303 by a link plate 304 and a spring 305. When the slider 306 slides, the throw bolt 303 also slides through the deadbolt outer body 302, and extends through an opening in the deadbolt plate 301 and into the strike lining box 402 in the door frame if the door is closed.

Additionally, a magnetic sensor 310 is arranged in a lower portion of the deadbolt inner body 309. A magnet (not shown) is also arranged in a lower portion of the strike plate 401 or the strike lining box 402. If the door in which the deadbolt assembly is arranged is closed, the magnet in a lower portion of the strike plate 401 or the strike lining box 402 may be sensed by the magnetic sensor 310, thus informing the magnetic sensor 310 that the door is closed. The magnetic sensor 310 may be connected to a circuit (not shown) such as the internal printed circuit board (PCB) 126 (shown in FIG. 4) via an auto-lock sensor cable (not shown), and the magnetic sensor 310 may send a signal to the circuit upon sensing the magnet. A sensor 310 may sense other properties of the door frame or components coupled thereto without deviating from the scope of the invention. Other properties that may be sensed include such properties as current, voltage, capacitance, magnetic field, electrical field, pressure, force, and/or signals, such as radio frequency signals. Thus, the sensor 310 is not limited to a magnetic sensor.

If the deadbolt includes a feature to turn the automatic locking function associated with the magnetic sensor 310 on and off, then the circuit may evaluate the status of the automatic locking function upon receipt of the signal from the magnetic sensor 310. For example, if the automatic locking function is turned off when the circuit receives the signal from the magnetic sensor 310, then the circuit may not take any action. However, if the automatic locking function is turned on when the circuit receives the signal from the magnetic sensor 310, the circuit may send a second signal in response to receiving the signal from the magnetic sensor 310. The second signal may be a signal that initiates the turning of the rotary bar 121 such that the rotary bar arm 308 is turned into a locked position. Thus, unlike conventional automatic locking systems, the automatic locking system according to an exemplary embodiment of the present invention does not include a timed locking mechanism. Rather, the automatic locking function may be performed in response to a detection of the proximity between the magnetic sensor 310 on the deadbolt assembly and a magnet on the door frame.

Further, the proximity between the magnetic sensor 310 on the deadbolt assembly and a magnet on the door frame may be set to an optimal dimension such that the magnetic sensor 310 does not detect the magnet before the door is closed. For example, there may be a gap of no more than approximately 3/16 inches between the magnetic sensor 310 on the deadbolt assembly and the magnet on the door frame before the magnetic sensor 310 senses the magnet. This gap may be adjusted if the distance between the magnetic sensor 310 and the magnet is different than a preset setting of the magnetic sensor 310 when the door is closed.

FIG. 3 is an exploded perspective view of an external body of the deadbolt shown in FIG. 1.

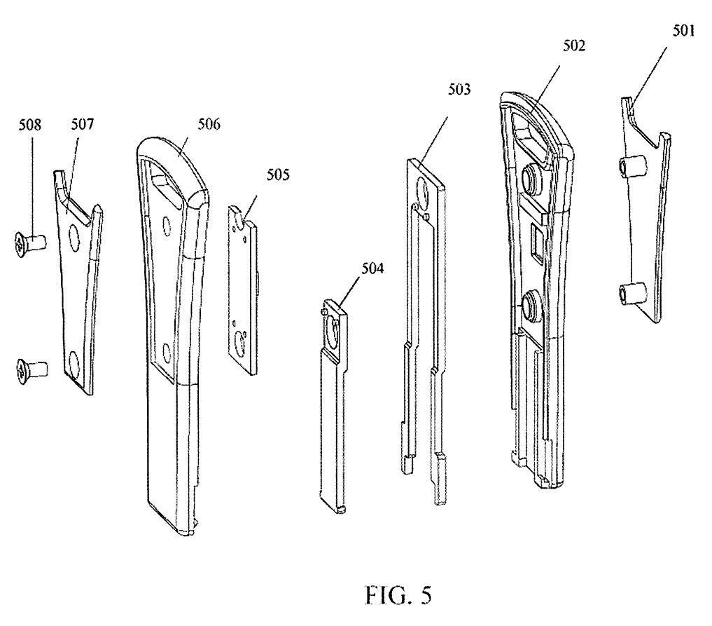

The external body assembly 200 of the deadbolt includes an external body 201, which includes an opening in which touch terminals 210 and 211 may be arranged. As will be explained in more detail, the touch terminals 210 and 211 may include a touch minus terminal 210 and a touch plus terminal 211, may be arranged in the opening of the external body 201, for touching a tag thereto. A tag may be referred to herein as a tag, a tag key, an electronic key, or an electronic tag, and will be described in more detail with reference to FIG. 5.

The external body 201 may include horizontal and vertical supports through which keys of a keypad 214 may extend. The horizontal and vertical supports may both be included, rather than just horizontal supports or just vertical supports, to improve the strength of the external body 201 around the keypad 214, and to reduce the risk of damage to an external PCB 218 by a potential intruder. The keypad 214 may have twelve standard numeric keypad keys and a thirteenth button accessible through a small opening in the external body 201. The small opening is shown on the upper left of the keypad region of the external body 201. The thirteenth button may have features associated with programming the deadbolt or with resetting the deadbolt's control software. The small opening may be arranged in a position of the external body 201 that is covered by the keypad cover 202 regardless of whether the keypad cover 202 is open or closed.

The keypad cover 202 may have protrusions that fit into grooves in the external body 201 such that the keypad cover 202 may slide up and down along the length of the external body 201. A badge 206 may be arranged on the outside of keypad cover 202, and may advertise a logo or name of the deadbolt vendor. A cover stopper 207 may be coupled to the external body 201 with a screw, and may contact and lock into a groove arranged on the inside of the keypad cover 202 to prevent the keypad cover 202 from sliding off the external body 201.

A magnet 203 may be coupled to the keypad cover 202 by a magnet holder 205 and a gasket material, such as magnet rubber 204. A magnet sensor 224 may be arranged on the external PCB 218 in a position corresponding to the position of the magnet 203 when the keypad cover 202 is in a closed position. For the purposes of this description, the “closed position” shall refer to a position of the keypad cover 202 where the keypad cover 202 covers the keypad 214. When the keypad cover 202 is raised from the closed position, the magnet 203 moves away from the magnet sensor 224. The magnet sensor 224 may send a signal to the internal PCB 126. The internal PCB 126 may lock the deadbolt in response to the signal. Additionally, a key entry or a combination of key entries on the keypad 214, such as pressing the number “0,” may be programmed to lock the deadbolt.

The keypad 214 may have support columns arranged on the back of each key such that one support column contacts a switch on the external PCB 218. Additional support columns may be included for each key such that the application of a large force on a single key may be distributed among multiple support columns to distribute the transmission of the force on the key to the external PCB 218. Further, the support column that contacts a switch on the external PCB 218 may be shorter than the additional support columns, and may include a nipple having a reduced cross-section so that the force distributed to the switch is further reduced and the risk of damage to the switch is reduced.

Light emitting diodes (LEDs) may be arranged on the external PCB 218 and facing the keys of the keypad 214. When a key is pressed by the user or when the keypad cover 202 is slid up by the user, the LEDs may illuminate, thus illuminating the keypad 214 for ease of passcode entry.

Additionally, the wires on external PCB 218 for the keypad 214 are arranged on a lower portion of the external PCB 218. In the event that the external PCB 218 is damaged in a location corresponding to the keypad 214, the remaining functions of the deadbolt may still operate even if the external PCB 218 corresponding to the keypad 214 is damaged and inoperable. For example, a user may still unlock the deadbolt with a recognized tag in the manner described in more detail below.

Below the keypad region, the external body 201 may include openings through which a 9V terminal cover 215, a 9V temporary plus terminal 216, and a 9V temporary minus terminal 217 protrude. The 9V temporary plus terminal 216 and the 9V temporary minus terminal 217 may be separated and insulated from the external body 201 by the 9V terminal cover 215.

The 9V temporary plus terminal 216 and the 9V temporary minus terminal 217, which will be referred to collectively as “the 9V temporary terminals 216 and 217,” may provide temporary power to the external PCB 218 from the exterior of a door on which the deadbolt is installed in the event that the power supply 104 in the internal body 100 has insufficient power to operate the motor 124 (shown in FIG. 4). Specifically, the terminals of a charged 9V battery may be held up to contact the 9V temporary terminals 216 and 217 to temporarily power the deadbolt. While the 9V battery terminals are contacting the 9V temporary terminals 216 and 217, the user may enter a recognized passcode into the keypad 214 or touch a recognized tag to the touch terminals 210 and 211, and the motor 124 may operate to unlock the deadbolt and permit the user to open the door.

If the batteries in the internal body 100 have insufficient power to operate the motor 124, this may be indicated by the lack of LED illumination on the keypad 214 when the keypad cover 202 is opened.

Further, to reduce the risk of failure in the event of a high-voltage attack to the 9V temporary terminals 216 and 217, the external PCB 218 may include a bypass circuit that prevents transmission of a high-voltage attack to the internal PCB 126 or the other components therein. As explained above, even if the external PCB 218 is damaged in the vicinity of the keypad 214, the remaining functions of the deadbolt may still operate. For example, a user may still unlock the deadbolt with a recognized tag.

Below the 9V temporary terminals 216 and 217, the external body 201 may include weep holes to permit the drainage of water that may infiltrate inside the external body 201 due to rain, sprinkler systems, condensation, humidity or other environmental conditions. Additionally, the external PCB 218 may be coated by a waterproof or water-resistant material such as silicone to reduce or prevent water-based damage.

The external PCB 218 includes an electronic key touchpad, including a touch plus cover 213, a small waterproof rubber 212, a touch plus terminal 211 insulated from a touch minus terminal 210 by the touch plus cover 213, a touch minus cover 209, and a large waterproof rubber 208. The touch minus terminal 210 and the touch plus terminal 211 will be referred to herein as touch terminals 210 and 211. The large waterproof rubber 208 creates a seal with the opening in the external body 201 to reduce or prevent the infiltration of water inside the external body 201. The touch minus terminal 210 contacts a first terminal on the first side of the external PCB 218. The touch plus terminal 211 contacts a touch plus fixture 220 arranged on a second side of the external PCB 218. The touch plus fixture 220 contacts a second terminal on the external PCB 218 to form a complete circuit with the first terminal when a tag is touched to the touch terminals 210 and 211.

An external bracket 222 is coupled to the external body 201 with screws 230, and includes screw receptacles 151 to receive mounting screws 150 and to couple the external body assembly 200 with the internal body 100. An external bracket rubber 223 is interposed between the external bracket 222 and a door on which the deadbolt is arranged to prevent or reduce damage to the door from the deadbolt and to prevent or reduce water seepage. The external bracket rubber 223 includes an opening to permit the screw receptacles 151 and door support of the external bracket 222, and the cables leading from the external PCB 218 to the internal PCB 126 to pass through the external bracket rubber 223 and the opening of the door. The opening of the door may be a standard opening in the United States, which may have a diameter of 2⅛^{th} inches. Further, no additional openings need be prepared in the door for installation of a deadbolt according to an exemplary embodiment of the present invention. Thus, the deadbolt according to an exemplary embodiment of the present invention may be used with a standard-sized deadbolt opening without requiring a homeowner or business owner to drill additional holes in the door during installation of the present deadbolt. The external bracket 222 may include an opening to receive cable stopper 221, through which cables leading from the external PCB 218 to the internal PCB 126 may pass.

The external finish appearance of the external body 201 may be consistent with the external finish appearance of the keypad cover 202. For example, the external finish appearance of these components may be any architectural finish commonly used for standard door hardware, such as chrome, brushed nickel, brushed aluminum, stainless steel, brass, or bronze. Additionally, the materials used to fabricate these components may be strong and with a sufficient thickness to resist or minimize damage and/or penetration by a potential intruder.

FIG. 4 is an exploded perspective view of an internal body of the deadbolt shown in FIG. 1.

Referring to FIG. 4, the deadbolt may include a feature to turn the automatic locking function on and off. This feature may be controlled by an auto-lock button 110 arranged on the internal body 100. The auto-lock button 110 may have a first position corresponding to an off-state of the automatic locking function, and a second position corresponding to an on-state of the automatic locking function. The position of the auto-lock button 110 may be detected by the internal PCB 126 so that the internal PCB 126 responds appropriately to a signal from the magnetic sensor 310 in the deadbolt assembly 300. An auto-lock spring 115 may provide resistance when shifting the auto-lock button 110 from the first position to the second position, and vice-versa, and may also restrain the auto-lock button 110 in the first position or second position. The auto-lock button 110 may be coupled to an auto-lock fixture 119, which is arranged inside the internal body 100. The auto-lock fixture 119 may include a protrusion that extends between terminals of a photosensor arranged on the internal PCB 126, and the photosensor may send a signal having a value to indicate that the auto-lock button 110 is in the ON position.

The internal body 100 also includes a manual override handle 111. The manual override handle 111 is coupled to the rotary bar holder 123 through screws, which may be fastened to screw receptacles in the manual override handle 111. The rotary bar holder 123 is coupled to the rotary bar 121. Therefore, the manual override handle 111 may be turned manually to lock and/or unlock the deadbolt in the event that the power supply is diminished, or if fire or other physical damage has rendered the internal PCB 126 partially or completely inoperable. Further, the manual override handle 111, the rotary bar holder 123, and the rotary bar 121 may all be fabricated from a sturdy and durable material, such as steel or aluminum, with a high melting temperature such that the manual override handle 111 may be operable to lock and/or unlock the deadbolt even if the deadbolt is exposed to extremely high or cold temperatures. Conversely, on conventional products, fire or other sources of high temperature can melt the emergency mechanisms, thus rendering the door lock inoperable in such emergency conditions.

An opening in the center of the manual override handle 111 may house an open/close button 112. An open/close button spring 113 may be interposed between the open/close button 112 and the internal body 100. The open/close button 112 may contact an open/close PCB 116 when the open/close button 112 is pushed, and the open/close PCB 116 may send a signal to the motor 124 through the internal PCB 126, which causes the rotary bar 121 to turn to a locked position or unlocked position, depending on its current state prior to the pushing of the open/close button 112.

The rotary bar 121 includes protrusions on the end corresponding to the rotary bar holder 123. The protrusions extend to fit inside protrusion receptacles in an inner opening in the rotary bar holder 123. The other end of the rotary bar 121 extends out from the front portion of the opening in the rotary bar holder 123 to engage the rotary bar arm 308 of the deadbolt assembly 300. A rotary bar cover 120 is coupled to the rotary bar holder 123 and covers the rear portion of the opening in the rotary bar holder 123 such that the rotary bar 121 protrusions are substantially secured inside the rotary bar holder 123. A rotary bar spring 122 is interposed between the protrusions in the rotary bar 121 and a protruding edge of the front portion of the opening in the rotary bar holder 123. Thus, the rotary bar spring 122 maintains the axial position of the rotary bar 121.

Of the three arms shown on the rotary bar holder 123, one arm may extend such that it contacts a protrusion on the open/close cable guide 117 to limit the permissible degree of rotation of the rotary bar 121, and therefore to limit the axial extension and/or retraction of the throw bolt 303. The protrusion of the open/close cable guide 117 may also correspond to a position of cables leading from the open/close PCB 116 to the internal PCB 126. Therefore, the contact between the one arm of the rotary bar holder 123 and the protrusion on the open/close cable guide 117 may prevent the rotary bar holder 123 from contacting and damaging such cables.

The motor 124 may include a gear coupled with a gear on the rotary bar holder 123 such that the motor 124 gear turns the gear on the rotary bar holder 123 to turn the rotary bar 121. Alternatively, although not shown, the motor 124 may directly drive the rotary bar 121 through a gear on the rotary bar 121. The motor 124 may be arranged inside the internal body 100 and secured in position with a motor bracket 125, which is coupled to an interior surface of the internal body 100.

A cable holder 128 may be coupled to the internal body 100, and may include a hook or guide to prevent wires and/or cables leading from the external body assembly 200 to the internal PCB 126.

The battery cover 102 may include battery cover cushions 102a to hold batteries as a power supply 104 in place. For aesthetic reasons, the battery cover screw 101a may be covered with the battery cover fastener 101 having an external appearance that is consistent with the external appearance of the battery cover 102. The external finish appearance of the battery cover 102 may be consistent with the external finish appearance of the internal body 100 and the external appearance of the screw covers 105 and 106. For example, the external finish appearance of these components may be any architectural finish commonly used for standard door hardware, such as chrome, brushed nickel, brushed aluminum, stainless steel, brass, or bronze. Additionally, the materials used to fabricate these components may be strong and with a sufficient thickness to resist or minimize damage and/or penetration by a potential intruder.

A protection guide 127 may be arranged to cover a portion of the internal body 100 components to protect these components in the event that an intruder removes the external body assembly 200 from a door and attempts to unlock the deadbolt by manipulating components of the internal body 100. The protection guide 127 may be fabricated from a sturdy and durable material, such as steel or aluminum, with a high melting temperature.

A light emitting diode (LED) on the internal PCB 126 may be arranged proximately with an LED diffuser 114. The LED may illuminate upon certain conditions of the deadbolt, such as if the batteries are low, and the LED diffuser 114 may make the illumination visible outside the internal body 100 to a user of the deadbolt.

A passcode registration button 108 and a key registration button 109 may protrude through openings in the internal body 100 above the battery holder 118, and may contact associated buttons on the internal PCB 126. The associated buttons may respectively control the programming of the passcodes and the tags recognized by the deadlock. These features related to programming will be described in more detail below.

FIG. 5 is an exploded perspective view of an electronic tag used with the deadbolt shown in FIG. 1.

Referring to FIG. 5, an electronic tag may include a top body 502 coupled with a bottom body 506 to house a tag minus terminal 503, a tag plus terminal 504, and a tag PCB 505. For aesthetic purposes, the top body 502 may include a top deco plate 501, and the bottom body 506 may include a bottom deco plate 507. Screws 508 may couple the components of the electronic tag together.

When the tag is touched to the deadbolt, the tag minus terminal 503 may contact the touch minus terminal 210, and the tag plus terminal 504 may contact the touch plus terminal 211 such that an electrical circuit is completed, and a code associated with the tag is transmitted from the tag PCB 505 to the internal PCB 126 of the internal body. If the code corresponds to a code recognized and accepted by the deadbolt, the internal PCB 126 may send a signal to the motor 124, and motor 124 may operate the rotary bar 121 such that the rotary bar arm 308 is turned to the unlocked position.

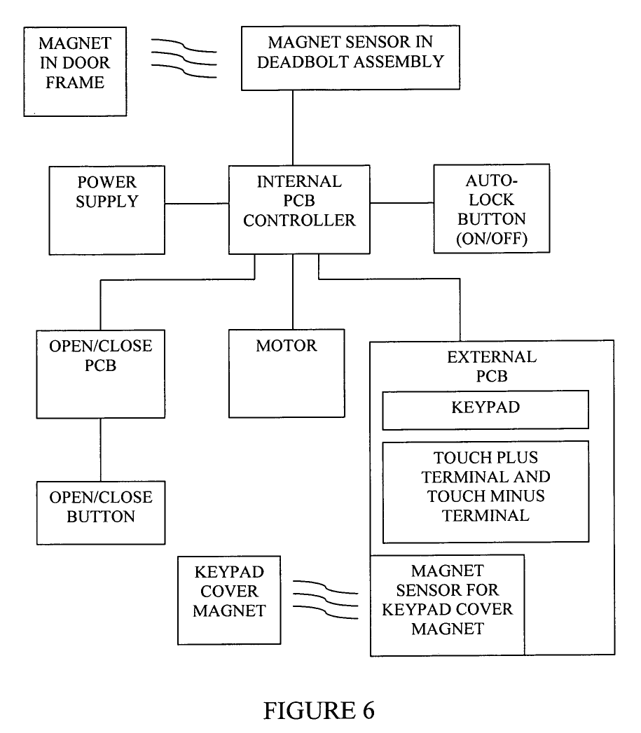

FIG. 6 is a circuit diagram for the deadbolt shown in FIG. 1.

Referring to FIG. 6, an arrangement of a circuit will be described. A controller of the internal PCB 126 is coupled to a magnetic sensor 310 of the deadbolt assembly 300, which senses a proximity of a magnet, such as a magnet arranged on a door frame. The internal PCB controller is also coupled to the power supply 104 and to the auto-lock button 110, which may be in an on-position or an off-position. The internal PCB controller is also coupled to the motor 124, to the open/close PCB 116, which is coupled to the open/close button 112, and to the external PCB 218. The external PCB 218 includes the keypad 214, the touch plus terminal 210 and touch minus terminal 211 (collectively, the touch terminals 210 and 211, which make up part of the electronic key touchpad), and the magnet sensor 224 to sense the magnet 203 in the keypad cover 202. The operation of the circuit has been described in detail above, and the description will not be repeated.

A deadbolt according to another exemplary embodiment of the present invention may include a master function that can be turned on or turned off at the discretion of a user. According to the master function, there may be a master tag and a master passcode. The master tag and master passcode may be in the possession of a landlord or management office, for example, if the deadbolt is used to lock a door on a rented space. The landlord or management office may create one or more user tags and user passcodes, which are distributed to tenants. For example, if the deadbolt is used on a primary entrance to a property having many tenants, the deadbolt arranged at the primary entrance may recognize one or more user passcodes, where each user passcode is associated with one or more tenants in the property. Similarly, the deadbolt arranged at the primary entrance may recognize one or more user tags, such as up to twenty different user tags, where each user tag is associated with one or more tenants in the property. Additional deadbolts may be arranged on the entrances of various apartments in the property. A deadbolt arranged on an apartment of tenant X may recognize a user passcode and a user tag associated with tenant X. The user passcode and user tag associated with tenant X may be changed by tenant X without affecting the deadbolt's recognition of the master tag and master passcode. Further, under the master function, both the deadbolt at the primary entrance of the property and the deadbolt on the tenant's apartment door may be programmed to recognize the landlord or management office's master passcodes and master tags, which may be the same or may be different for the two deadbolts.

If tenant X then moves out of the apartment, tenant X's apartment user passcode and user tag may be deleted from the list of tenant X's apartment deadbolt by the landlord or management office without deleting the master passcode or master tag from that deadbolt.

Similarly, tenant X's primary entrance user passcode and user tag may be deleted from the primary entrance's deadbolt by the landlord or management office without deleting the master passcode or master tag, or other user passcodes or user tags, from that primary entrance's deadbolt.

Conventionally, the master function has been either implemented into deadbolts or not implemented at the factory, but there has not been a way to turn on or turn off the master function once the deadbolt is installed on a door. Therefore, customers wishing to purchase a deadbolt had to specify whether to purchase a deadbolt with the master function or a deadbolt without the master function at the time of ordering or purchasing a deadbolt.

According to another embodiment of the present invention, a deadbolt may include a master function that may be turned on or turned off according to a customer's desire without having to return the deadbolt to a manufacturer for reflashing or reinstalling the deadbolt software.

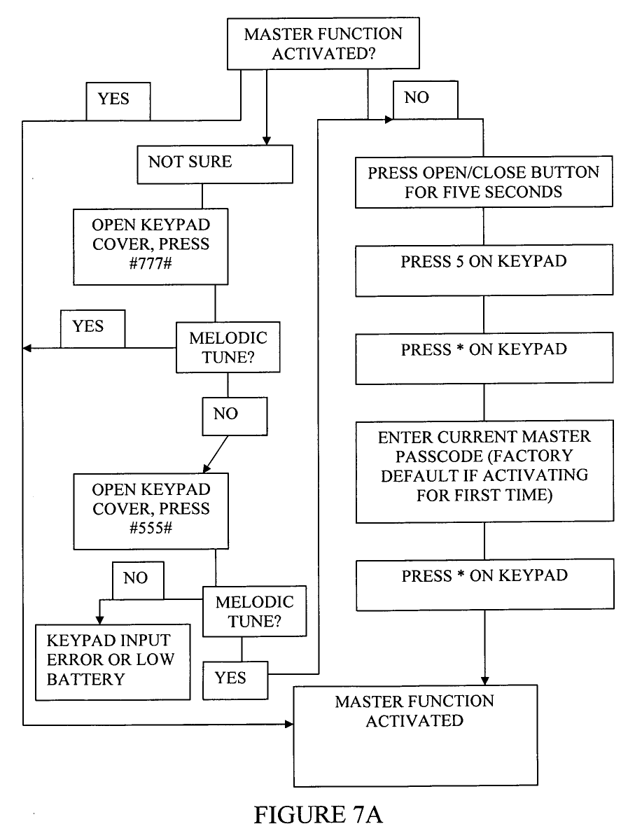

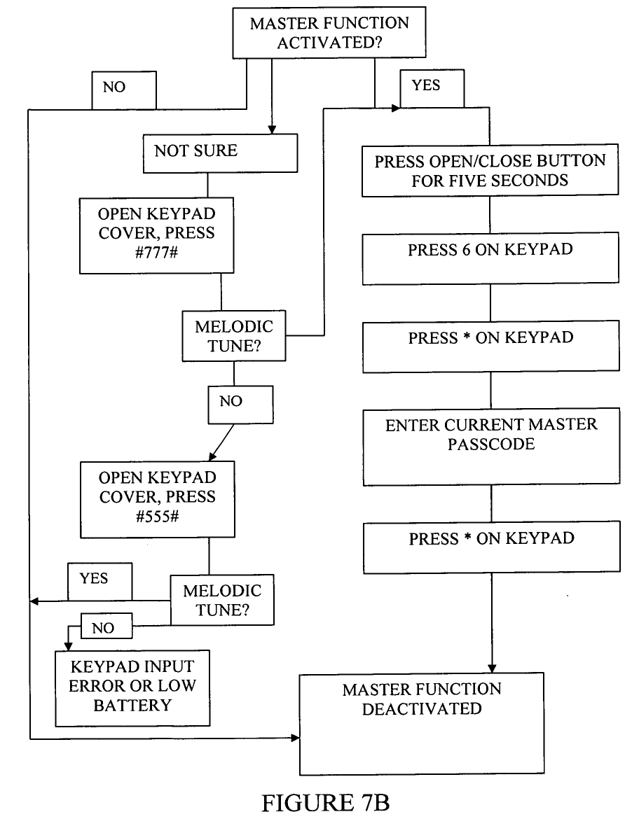

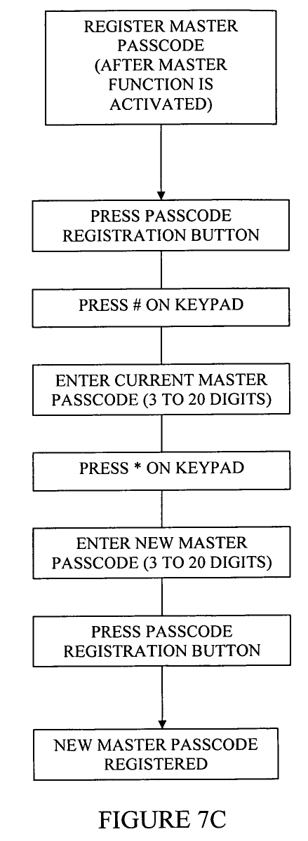

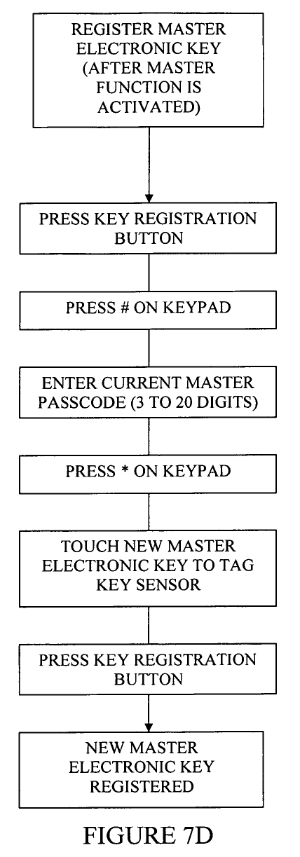

FIG. 7A is a flow chart showing a method for activating a master function in the deadbolt shown in FIG. 1. Referring to FIG. 7A, a user may first determine whether the master function is activated. If yes, then no further operation is necessary. If the user is not sure, the user may open the keypad cover and press “#777#” on the keypad. If a melodic tune emits from the deadbolt, the master function is activated and no further operation is necessary. If no melodic tune emits, then the master function is deactivated or the power supply is low. The user may then open the keypad cover and press “#555#” on the keypad. If a melodic tune emits from the deadbolt, the master function is deactivated. If no melodic tune emits, there may be a low power supply or keypad input error, and the user may wish to replace the power supply or repeat the process of determining whether the master function is activated.

If the user determines that the master function is deactivated, the user may activate the user function by first pressing the open/close button for five seconds. Then the user may press the numeral “5” on the keypad. The user may then press the star “*” on the keypad. Then the user may enter the current master passcode. If the user has not set a master passcode, the master passcode may be set to the factory default master passcode, such as 1234, 1111, 9999, or some other passcode. The user may then press the star “*” on the keypad, and the master function may be activated.

FIG. 7B is a flow chart showing a method for deactivating a master function in the deadbolt shown in FIG. 1.

Referring to FIG. 7B, a user may first determine whether the master function is activated. If no, then no further operation is necessary. If the user is not sure, the user may open the keypad cover and press “#777#” on the keypad. If a melodic tune emits from the deadbolt, the master function is activated. If no melodic tune emits, then the master function is deactivated or the power supply is low. The user may then open the keypad cover and press “#555#” on the keypad. If a melodic tune emits from the deadbolt, the master function is deactivated. If no melodic tune emits, there may be a low power supply or keypad input error, and the user may wish to replace the power supply or repeat the process of determining whether the master function is activated.

If the user determines that the master function is activated, the user may deactivate the master function by first pressing the open/close button for five seconds. Then the user may press the numeral “6” on the keypad. The user may then press the star “*” on the keypad. Then the user may enter the current master passcode. If the user has not changed the master passcode, the master passcode may still be set to the factory default master passcode as explained above. The user may then press the star “*” on the keypad, and the master function may be deactivated. Thus, the master function may not be deactivated if the user does not have the master passcode. Further, once the master function is deactivated, the master passcode may be reset to the factory default master passcode.

FIG. 7C is a flow chart showing a method for registering a master passcode using the master function in the deadbolt shown in FIG. 1.

Referring to FIG. 7C, after the master function has been activated, such as by the procedure described above, the master passcode may be registered. First, a user may press the passcode registration button 108. Next, the user may press the number symbol “#” on the keypad. Then, the user may enter the current master passcode, followed by the star “*” on the keypad. As noted above, if the user has activated the master function for the first time, or is registering a new master passcode for the first time, the master passcode may be the factory default master passcode. The user may then enter a new master passcode followed by the passcode registration button 108. The new master passcode may then be registered with the deadbolt. According to another exemplary embodiment of the present invention, the user may confirm the new master passcode by entering the new master passcode two or more times.

FIG. 7D is a flow chart showing a method for registering a master electronic key using the master function in the deadbolt shown in FIG. 1.

Referring to FIG. 7D, after the master function has been activated, such as by the procedure described above, a master electronic key may be registered. First, a user may press the key registration button 109. Next, the user may press the number symbol “#” on the keypad. Then, the user may enter the current master passcode, followed by the star “*” on the keypad. As noted above, if the user has activated the master function for the first time, or has not previously registered a new master passcode, the master passcode may be the factory default master passcode. The user may then touch the new master electronic key to the electronic key touchpad, followed by the key registration button 109. The new master electronic key may then be registered with the deadbolt. According to another exemplary embodiment of the present invention, the user may confirm the new master electronic key by touching the new master electronic key to the electronic key touchpad two or more times. According to another exemplary embodiment of the present invention, the user may register additional new master electronic keys by touching the additional new master electronic keys to the electronic key touchpad one or more times.

The process of activating and deactivating the master function, and registering a master passcode and master electronic key, may be performed using a combination of keypad entries as shown in FIG. 7A, FIG. 7B, FIG. 7C, and FIG. 7D.

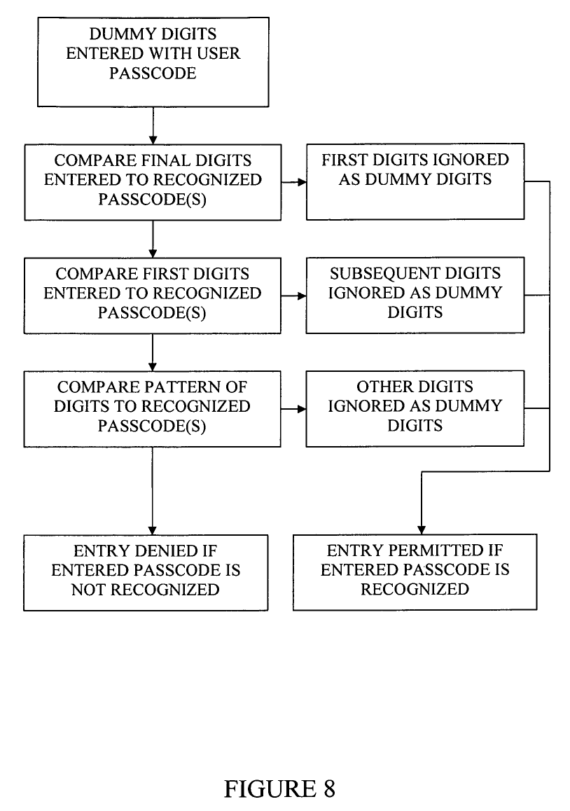

FIG. 8 is a flow chart showing a method for receiving a user passcode by a deadbolt according to an exemplary embodiment of the present invention. Although described for a user passcode, this method may be equally applicable to a master passcode.

In the event that a user does not wish to reveal his or her passcode to an observer, a deadbolt according to another exemplary embodiment of the present invention may permit a user to enter the user's passcode in conjunction with a series of dummy digits that are ignored by the deadbolt. For example, the user may enter a number of dummy digits before the user's passcode, and the dummy digits may be ignored by the deadbolt. Alternatively, the user may enter a number of dummy digits after the user's passcode, and the dummy digits may be ignored by the deadbolt. Alternatively, the user may enter a number of dummy digits in some other pattern with the user's passcode, such as every other entered digit is a dummy digit, and the dummy digits may be ignored by the deadbolt. In these examples, and as shown in FIG. 8, the deadbolt may ignore the dummy digits and compare the first entered digits, final entered digits, or digits according to a pattern against recognized user passcodes. Additionally, a deadbolt according to the present invention may not include every combination of recognizing dummy digits. For example, a deadbolt may only recognize dummy digits entered before the user's passcode, or may only recognize dummy digits entered after the user's passcode.

A deadbolt according to exemplary embodiments of the present invention may also include an alarm with a variable-controlled volume. The alarm may be programmed to emit an audible sound upon the occurrence of different events. For example, the alarm may emit an audible sound in the event of a forced entry where the door is opened while the deadbolt is locked such as by breaking the door or door frame. Additionally, in the event that the throw bolt cannot be fully extended, either because the door is closed with the deadbolt latch already extended or because the door is not fully closed, the deadbolt may retract the throw bolt and the deadbolt may emit the audible sound to indicate a door-closing error.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An automatic door-locking system, comprising:
a magnet arranged on a door frame;
a magnetic sensor arranged on a door corresponding to the door frame, the magnetic sensor to sense a proximity of the magnet and to send a signal in response thereto; and
a locking assembly comprising a throw bolt,
wherein the throw bolt extends into a strike lining box on the door frame in response to a signal from the magnetic sensor.

2. The automatic door-locking system of claim 1, wherein the magnetic sensor is arranged in or adjacent to the locking assembly.

3. The automatic door-locking system of claim 1, wherein the magnet is arranged in or adjacent to the strike lining box.

4. The automatic door-locking system of claim 1, wherein the magnetic sensor and magnet are not visible from a first vantage outside the door and are not visible from a second vantage inside the door.

5. The automatic door-locking system of claim 1, wherein the throw bolt extends into the strike lining box when the proximity between the magnetic sensor and the magnet is 3/16 inches or less.

6. The automatic door-locking system of claim 1, further comprising:
a controller; and
a motor,
wherein the controller operates the motor to extend the throw bolt in response to receiving the signal from the magnetic sensor.

7. The automatic door-locking system of claim 6, wherein the controller operates the motor a predetermined time after receiving the signal from the magnetic sensor.

8. The automatic door-locking system of claim 6, wherein the controller checks a status of an auto-lock button upon receiving the signal before operating the motor, the auto-lock button having a first position corresponding to an on-state, and a second position corresponding to an off-state.

9. A deadbolt, comprising:
an internal panel arranged on an interior side of a door;
an external panel arranged on an exterior side of the door;
a deadbolt assembly comprising a throw bolt, the deadbolt assembly being interposed between the internal panel and the external panel;
a magnet arranged on a frame of the door; and
a magnetic sensor arranged on the door, the magnetic sensor to sense a proximity of the magnet and to send a signal in response thereto,
wherein the throw bolt extends into a strike lining box on the door frame in response to a signal from the magnetic sensor.

10. The deadbolt of claim 9, further comprising:
a manual override handle coupled with a rotary bar, the rotary bar connected to the deadbolt assembly,
wherein the throw bolt extends into or retracts from the strike lining box if the manual override handle is turned.

11. The deadbolt of claim 10, wherein the manual override handle, the rotary bar, and the deadbolt assembly are manufactured from a material having a high melting temperature.

12. The deadbolt of claim 9, wherein the magnetic sensor is arranged in or adjacent to the deadbolt assembly.

13. The deadbolt of claim 9, wherein the magnet is arranged in or adjacent to the strike lining box.

14. The deadbolt of claim 9, wherein the internal panel comprises:
a controller; and
a motor,
wherein the controller operates the motor to extend the throw bolt in response to receiving the signal from the magnetic sensor.

15. The deadbolt of claim 14, wherein the controller checks a status of an auto-lock button upon receiving the signal before operating the motor.

16. The deadbolt of claim 14, further comprising power terminals on the external panel, the power terminals for receiving power to operate the motor.

17. The deadbolt of claim 9, wherein the external panel comprises at least one of a keypad to receive an entered passcode and a touchpad to receive a signal from an electronic key.

18. An electronic deadbolt, comprising:
an internal panel comprising a controller and a motor;
an external panel; and
a deadbolt assembly comprising a throw bolt, the throw bolt being extendable by the motor in response to a recognized command,
wherein the controller comprises a master function, the master function being activated or deactivated by a user.

19. The electronic deadbolt of claim 18, wherein if the master function is activated, the recognized command comprises a user passcode entered into a keypad arranged on the external panel, or a master passcode entered into the keypad.

20. The electronic deadbolt of claim 18, wherein if the master function is activated, the recognized command comprises a user electronic key contacting a touchpad arranged on the external panel, or a master electronic key contacting the touchpad.
